(19) United States
(12) Patent Application Publication
(10) Pub. No.: US 2011/0177385 A1
(43) Pub. Date: Jul. 21, 2011

(54) CURRENT COLLECTOR FOR AN ELECTROCHEMICAL CELL

(75) Inventors: Jörg Kaiser, Kamenz (DE); Claus-Rupert Hohenthanner, Hanau (DE); Günter Eichinger, Altenstadt (DE); Heike Schöne, Elstra (DE); Beatrice Schäfer, Dresden (DE); Mykola Polyakov, Rostock (DE); Tim Schäfer, Niedersachswerfen (DE)

(73) Assignee: Li-Tec Battery GmbH, Kamenz (DE)

(21) Appl. No.: 13/003,255

(22) PCT Filed: Jul. 8, 2009
(86) PCT No.: PCT/EP09/04946

§ 371 Date: Mar. 24, 2011

(30) Foreign Application Priority Data
Jul. 9, 2008 (DE) 10 2008 032 270.9
Nov. 17, 2008 (DE) 10 2008 057 711.1

(51) Int. Cl. H01M 2/02; H01M 4/66

(52) U.S. Cl. 429/163; 429/245

(57) ABSTRACT

A current collector (1) according to the invention has at least one substantially plate-like and preferably thin-walled core region (2). This core region contains at least one electrically conductive third material. The current collector also has a first surface region (3) comprising at least one first material. The current collector also has a second surface region (4) comprising at least one second material. In this case, the electrical conductivity of the first surface region is lower than that of the second surface region. Furthermore, this first surface region is bounded and/or spatially separated from this second surface region.

The present invention relates to a current conductor for a galvanic cell as well as a galvanic cell having such a current conductor. The invention is described in regard to rechargeable galvanic cells, the electrolyte of which comprises lithium ions. The invention may also be used in the context of galvanic cells for single use and/or together with other electrolytes.

Rechargeable galvanic cells of different types are known from the prior art. For some of these types, it is common that operating security diminishes with increasing time of use. One object of the present invention is to increase the safety of such galvanic cells. This is achieved, in accordance with the present invention, by means of a current conductor or a galvanic cell, respectively, according to the independent claims. Preferred embodiments and further improvements are the subject-matter of the dependent claims.

The current conductor has at least one core area, which is predominantly in the shape of a plate and preferably is thin-walled. Said core area comprises at least one electrically conducting third material. The current conductor furthermore has a first surface area having at least one first material. Furthermore, the current conductor has a second surface area having at least one second material. Therein, the electrical conductivity of the first surface area is lower than the electrical conductivity of the second surface area. Furthermore, said first surface area is delimited or spatially separated, respectively, from said second surface area.

The current conductor according to the present invention is a solid body, which is intended to conduct electrical current in the context of galvanic cells. The current conductor also serves as electrical connection with a connecting means, for example a connecting cable. The current conductor is predominantly in the shape of a plate or a cuboid, respectively. The current conductor comprises two rectangular and predominantly parallel lateral areas, which are arranged at a distance from each other, respectively. Preferably, the current conductor is massive and has a low wall thickness. Therein, the minimum wall thickness of the current conductor is selected, among others, dependent on the electrical conductivity of the third material, the width of the current conductor perpendicular to the flow direction of the electrical current an the amperage of said electrical current.

The current conductor conducts electrical currents via its core area or the limiting surfaces thereof, respectively. Furthermore, said core area comprises at least one electrically conductive third material. The weight percentage of said third material is determined based on the ratio of the weight of the third material relative to the weight of the core area. This weight percentage is selected depending on the currents as encountered or their amperage, respectively, the dimensions of the current conductor and the electrical conductivity of the third material.

Furthermore, at least one first surface area having a first material is assigned to the current conductor. The first surface area is arranged on at least one lateral area of the current conductor and at least partly covers the same. The first material is different from the third material. Furthermore, at least one second surface area having a second material is assigned to the current conductor. The second surface area is arranged on at least one lateral area of the current conductor and at least partly covers the same. Said second surface area is different from the first surface area. Also, the second material is different from the first and the third material. The second surface area has a higher electrical conductivity than the first surface area.

The first and the second surface area of the current conductor are delimited from each other. This is understand to mean that there is no continuous transition between these two surface areas, while taking the technically feasible means of manufacture into account. In case such a transitional area existed, this would be due to the conditions of manufacture but not based on the concept of the present invention. It is very well included that these two surface areas touch or abut each other.

The galvanic cell according to the invention has at least an electrode, an electrolyte and a casing. Therein, the electrode comprises at least an active electrode mass and an aforementioned current conductor. The current conductor is at least in electrical contact with the active electrode mass. The casing is at least partially connected with the first surface area of the current conductor. Preferably, said connection is realized by material engagement. For example, said connection is realized by means of adhesives or by means of welding.

An electrolyte enables the conducting of ions between electrodes or their active electrode masses, respectively, in a galvanic cell. This electrolyte at least comprises lithium ions.

An active electrode mass stores energy in chemical form. The active electrode mass discharges ions into the electrolyte or receives ions from the electrolyte. The active electrode mass receives electrons from the current conductor or the core area thereof, or discharges electrons into the current conductor, or the core area thereof, respectively. The direction of the movement of said particles depends on whether the galvanic cell is discharged or charged.

The casing surrounds the galvanic cell in a gas-tight manner. Preferably, the casing is realized as a gas-tight foil. The casing is adapted to the shape of the current conductor.

An aforementioned galvanic cell has lithium or lithium ions, respectively. In case water enters the inside of such a galvanic cell, a strong chemical reaction with the lithium as present is possible. A galvanic cell compromised in that way may also explode. In case the current conductor or the galvanic cell, respectively, is realized in accordance with the present invention, the connection between the casing and the first surface area of the current conductor is suited to inhibit or significantly diminish said unwanted entrance of water. Thereby, the security of such galvanic cells is increased and the object underlying the present invention is solved.

Further preferred embodiments of the present invention are described in the following.

Preferably, said second material is a metal, preferably nickel, gold, platinum or another noble metal. The second material is intended to be more resistant against chemical attacks during the operation of the current conductor than said third material. Thereby, in particular, the electrical contacting with a connecting device is intended to be improved permanently.

Preferably, the first surface area and the second surface area are realized as thin layers, These layers are realized to be thinner than the thickness of the core area. Preferably, the thicknesses of the layers of the first or the second surface area, respectively, are less than 1/10 of the thickness of the core area. It is not required that the layers of the first and the second surface area completely cover a lateral area of the current conductor. For example, the layers may be realized as a lamellar or a spotted pattern on a lateral area.

Preferably, the third material, for the core area, is electrically conducting, preferably is a metal. Preferably, said third material is aluminium and/or copper. Therein, the weight percentage of said third material, relative to the overall weight of the core area, is at least 20% by weight, preferably at least 50% by weight, preferably at least 90% by weight, particularly preferred at least 95% by weight or, particularly preferred, at least 99.5% by weight, and preferably not more than 99.995% by weight.

Preferably, the second material is an electrically conducting material, preferably a metal. Preferably, said second material is nickel, wherein the weight percentage of the second material, relative to the overall weight of the second surface area, is at least 20% by weight, preferably at least 50% by weight, particularly preferred at least 90% per weight, particularly preferred at least 95% by weight, particularly preferred at least 99.5% by weight, and preferably not more than 99.995% by weight.

Preferably, the second material is selected from a group comprising aluminium oxide, chemical compounds comprising silicon and/or zirconium fluoride. This group is not meant to be closed. In respect to the first material, mixtures of at least two of these materials of this group are possible.

Preferably, the current conductor comprises at least one contact area. A contact area is realized as a part of the lateral area of the current conductor. The conduct area is intended to facilitate the influx of electrons into the current conductor or the core area thereof, respectively. Furthermore, the contact area is intended to allow electrons to be discharged out of the current conductor or the core area thereof, respectively.

Preferably, a contact area of a conductor is also intended to touch and to provide electrical contact with the active electrode mass. The active electrode mass is applied onto at least one contact area and is connected with the same in an electrically conducting manner. Therein, the core area of the current conductor conducts electrons from the active electrode mass in direction of the second surface area, via a contact area. Therein, the electrons are conducted, for example, into a cable. This cable leads to the load. The flow of electrons also occurs in the opposite direction, if necessary. Depending on the design, a plurality of contact areas of the current conductor may be provided with active electrode masses and may be connected in an electrically conducting manner. For example, the active electrode mass may be applied onto a foil-like current conductor as a paste.

Preferably, the casing is provided as a thin foil. Therein, the casing has at least one first layer. This layer preferably is gas-tight and, particularly preferably, is realized to be metallic. In particular, in case of a metallic first layer, it is advantageous, if the same is electrically isolated vis-à-vis the galvanic cell and is protected from chemical influences exerted by the electrolyte. Preferably, said first layer is at least partially coated on the inside and/or on the outside of the layer. Said coating comprises at least one fourth material, which is electrically non-conducting and which provides a tight coating of the casing. Preferably, said fourth material is a polymer, particularly preferred polyethylene and/or polypropylene. Preferably, said first layer has on its outside a further protective coating. This protective coating is intended to provide protection for the first layer vis-à-vis, for example, pointy foreign object and/or serves to additionally seal the galvanic cell. The casing is adapted to the shape of the current conductor.

A part of the casing is in the proximity of the first surface area of the current conductor, after the current conductors have been inserted. Preferably, a connection between the casing and the current conductor, or the first surface area, respectively, is herein achieved in material engagement. In order to improve adhesion, the fourth material preferably comprises polar groups in the proximity of the first surface area. These groups preferably are carbon-oxygen-groups. However, other polar groups or groups, which improve adhesion, are suitable.

Preferably, the current conductor at least partly protrudes out of the casing. The part of the current conductor protruding out of the casing serves the purpose to connect the electrode, for example, with an electrical cable. Preferably, the second surface area protrudes out of the casing. Preferably, the second surface area comprises an electrically conductive second material.

Under normal operating conditions, a galvanic cell is operated jointly with further galvanic cells. Preferably, the outer shape of the galvanic cell is adapted to a further galvanic cell. Preferably, the outer shape of the galvanic cell therein is predominantly cuboid. Thereby, waste of space between galvanic cells is avoided. Therein, the core area of the current conductor is advantageously adapted to the outer shape of said galvanic cell. Preferably, said current conductor is predominantly cuboid. Preferably, the casing is adapted to the shape of the current conductor. Thereby, waste of space is avoided and material for the casing is saved. For example, the casing is realized as a pocket that is rectangular and is closed along three edges. The galvanic cell is inserted into the casing via the fourth, open edge. By means of a suitable choice of the shape of the casing, the formation of distortions/wrinkles is avoided. Such distortions/wrinkles tend to age faster and may lead to breaches in the casing.

Depending on the application, the outer shape of the galvanic cell is predominantly cylindrical. In this design, the components of the galvanic cell are spirally would. Therein, also the current conductor is realized as a thin stripe-shaped foil and is spirally wound. The casing also is adapted to the shape of the current conductor or the galvanic cell, respectively.

Preferably, the electrolyte of the galvanic cell at least partly comprises an alkali metal or ions thereof. Particularly preferred, said alkali metal is lithium. By using this embodiment, particularly high energy and power densities are achieved.

Further advantages, features and possibilities for application of the present invention follow from the description given below in the context of the Figures. These show:

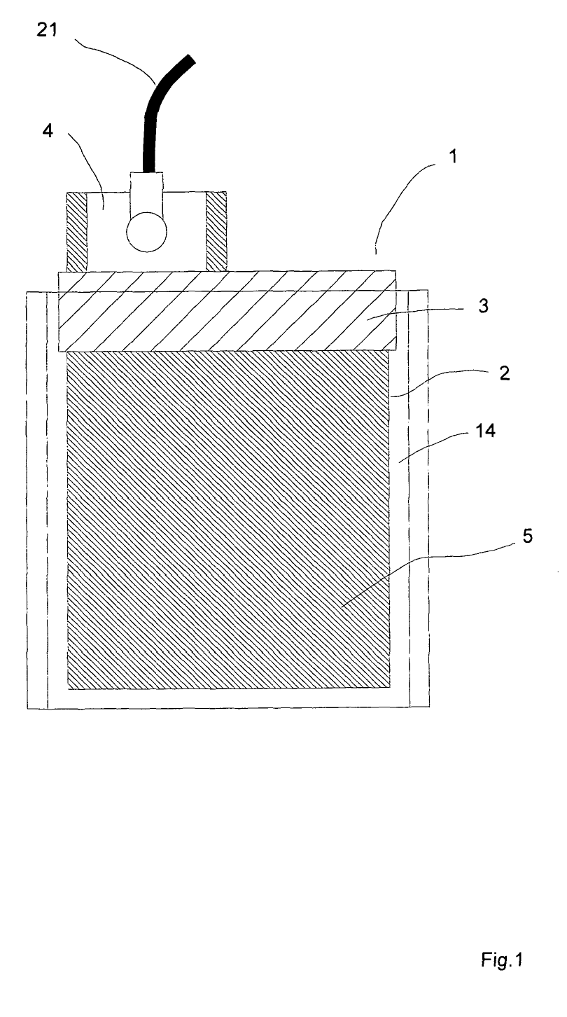

FIG. 1: Side view of a current conductor according to the invention.

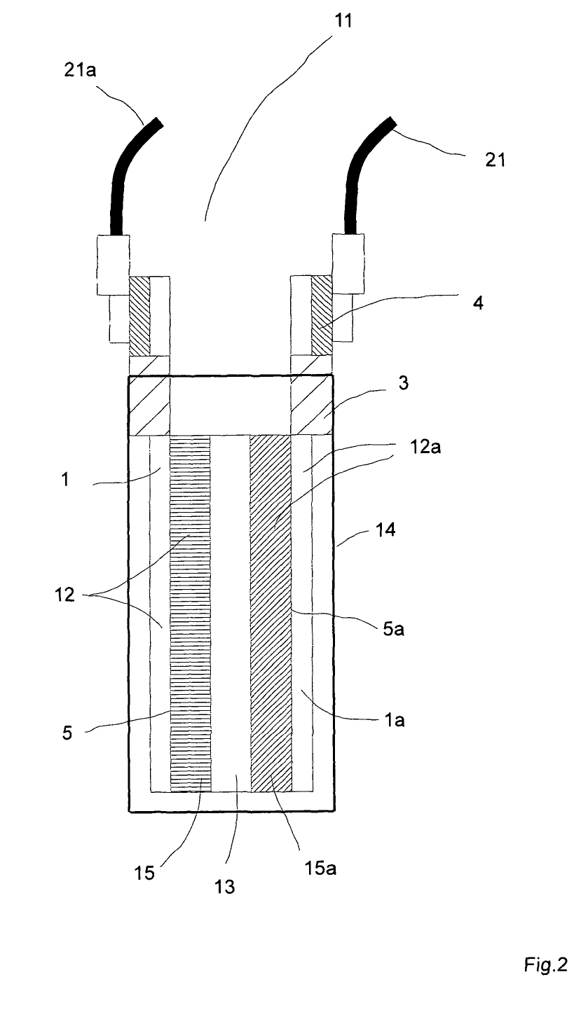

FIG. 2: Sectional view of a galvanic cell having the current conductors according to the present invention.

FIG. 1 shows a current conductor (1) according to the invention. The same is surrounded by casing (14) and connected with a current cable (21). Casing (14) is shown to be transparent in order to emphasize the set-up. The representation is not to scale.

This embodiment of current conductor (1) has a core area (2), a first surface area (3), a second surface area (4) and a contact area (5). Core area (2) is realized as rectangular aluminium foil. Current conductor (1) is supplemented at its upper end by a rectangular area of lesser width (same hatching). This area is shaped and has the second surface area (4). This surface area (4) is realized as a thin nickel layer. The nickel layer can be manufactured, for example, by means of electrolytic deposition, by means of rolling on of a nickel foil or by means of deposition from the vapor phase. Preferably, the second surface area is realized as a thin gold layer. The first surface area (3) is realized as a thin layer comprising aluminium oxide. This aluminium oxide layer is realized, for example, by means of chromatization or eloxation. A surface area (3) realized in that manner improves the adhesion of plastics or polymers, respectively, vis-à-vis an aluminium surface of the core area that is not treated. A gas-tight connection with casing (14) is realized in the first surface area (3).

Casing (14) is tucked at the lower end and comprises a hem at the right and the left edge, respectively. Therein, the material of the casing is connected in material engagement.

FIG. 2 shows a sectional view of a galvanic cell (11) according to the invention. The same is supplemented by feeding lines (21) and (21a), respectively. The representation is not to scale. In particular, the thickness ratio between the respective parts has not been considered.

The galvanic cell (11) comprises two electrodes (12, 12a), an electrolyte (13) and a casing (14). An electrode (12, 12a), comprises a current conductor (1, 1a) as well as an active electrode mass (15, 15a), respectively. Current conductor (1, 1a) and the respectively assigned active electrode masses are connected with each other in an electrically conducting manner. Current conductors (1, 1a) are current conductors in accordance with the present invention. These current conductors, respectively, have a first surface area (3) in order to achieve connection with casing (14) in material engagement and in a gas-tight manner. Furthermore, current conductor (1, 1a) has a second surface area (4) in order to achieve connection with current cable (21). Contact areas (5, 5a) of current conductor (1, 1a) for electrically contacting the active electrode masses (15, 15a) are also shown. Electrolyte (13) is arranged between electrodes (12, 12a) or the active electrode masses (15, 15a), respectively. Said electrolyte comprises lithium ions.

Casing (14) of this example is realized as an aluminium foil. The inner sides of this casing (14) are directed towards current conductors (1, 1a). The inner sides of casing (14) are continuously coated with polypropylene. In order to improve the adhesion of casing (14) to the first surface area (3), the polypropylene layer on the inner side of casing (14) is provided with polar carbon-oxygen groups. In order to improve adhesion, the PP-layer is, for example, oxidized by means of plasma discharge. Furthermore, casing (14) comprises an outer protective layer of PVC. In case the current conductor has sharp edges, a thin-walled flexible polymer strip, preferably made of polypropylene and/or polyethylene, is inserted between casing (14) and first surface area (3) of current conductor (1, 1a). This is meant to achieve a rounding of the sharp edge and is also meant to protect the casing.

1-15. (canceled)

16. A current conductor comprising:
a first surface area composed of at least one first material;
a second surface area composed of at least one second material, the first surface area delimited from the second surface area, the second surface area having an electrical conductivity that is higher than the first surface area; and
at least one core area having a predominantly plate-shape, the at least one core area composed of at least one electrically conductive third material.

17. The current conductor according to claim 16, wherein the at least one core area is thin-walled.

18. The current conductor according to claim 16, wherein the second material is metal.

19. The current conductor according to claim 16, wherein second material is at least one of nickel, gold, and platinum.

20. The current conductor according to claim 16, wherein the second material is a noble metal.

21. The current conductor according to claim 16, wherein the first surface area and the second surface area are realized as thin layers, the thickness of the thin layers of being less than the thickness of the core area.

22. The current conductor according to claim 21, wherein the thickness of the thin layers is less than 1/10 of the thickness of the at least one core area.

23. The current conductor according to claim 16, wherein the third material is a metal having a weight percentage that is at least one of 20%, 50%, 90%, 95%, 99.5% and 99.995% by weight of the at least one core area.

24. The current conductor according to claim 23, wherein the third material is at least one of aluminum and copper.

25. The current conductor according to claim 16, wherein the second material is a metal having a weight percentage that is at least one of 20%, 50%, 90%, 95%, 99.5% and 99.995% by weight of the at least one core area.

26. The current conductor according to claim 25, wherein the second material is nickel.

27. The current conductor according to claim 16, wherein the first material is selected from the group consisting of: aluminium oxide, silicon compounds and zirconium fluoride.

28. The current conductor according to claim 16, further comprising at least one contact area.

29. A galvanic cell comprising:
at least one electrode, the electrode having a current conductor comprising:
a first surface area composed of at least one first material,
a second surface area composed of at least one second material, the first surface area delimited from the second surface area, the second surface area having an electrical conductivity that is higher than the first surface area,
at least one core area having a predominantly plate-shape, the at least one core area composed of at least one electrically conductive third material, and
an electrode mass;
an electrolyte; and
a casing, wherein the casing is at least partially connected with the first surface area of the current conductor.

30. The galvanic cell according to claim 29, wherein the casing is materially engaged with the first surface area of the current conductor.

31. The galvanic cell according to claim 29, wherein the active electrode mass is arranged on a contact area of the current conductor and wherein the active electrode mass is connected with the contact area of the current conductor in at least an electrically conducting manner.

32. The galvanic cell according to claim 29, wherein the casing is realized as a thin-walled foil having at least one gas-tight first layer that is at least partially coated with a fourth material arranged on an inner side of the casing, the fourth material an electrically insulated material, the casing also having a protective layer on an outer side of the casing.

33. The galvanic cell according to claim 32, wherein the electrically insulated material is a polymer.

34. The galvanic cell according to claim 32, wherein the electrically insulated material is at least one of polyethylene and polypropylene.

35. The galvanic cell according to claim 32, wherein the fourth material comprises polar groups, wherein the polar groups are at least partially arranged in the proximity of the first area of the current conductor.

36. The galvanic cell according to claim 29, wherein the current conductor at least partially protrudes from the casing and wherein the second surface area protrudes from the casing.

37. The galvanic cell according to claim 29, wherein the outer shape of the galvanic cell is adapted to a further galvanic cell, wherein the outer shape of galvanic cell is predominantly cuboid, wherein the core area of the current conductor is adapted to the outer shape of the galvanic cell, wherein current conductor is realized to be predominantly cuboid, and wherein the casing is adapted to the shape of current conductor.

38. The galvanic cell according to claim 29, wherein the outer shape of galvanic cell is substantially cylindrical, wherein the current conductor is arranged spirally, and wherein the longitudinal axes of the galvanic cell and the spirally shaped current conductor are arranged essentially in parallel.

39. The galvanic cell according to claim 29, wherein the electrolyte at least temporarily comprises an alkali metal.

40. The galvanic cell according to claim 39, wherein the alkali metal is lithium.
